(19) United States
(12) Patent Application Publication
(10) Pub. No.: US 2025/0087995 A1
(43) Pub. Date: Mar. 13, 2025

(54) WIDE INPUT VOLTAGE RANGE SURGE SUPPRESSOR

(71) Applicant: AMETEK, INC., Berwyn, PA (US)

(72) Inventors: Matthew Bloom, Mount Prospect, IL (US); Pramod Kumar Rampelli, Bangalore (IN)

(73) Assignee: AMETEK, INC., Berwyn, PA (US)

(21) Appl. No.: 18/826,006

(22) Filed: Sep. 5, 2024

Related U.S. Application Data
(60) Provisional application No. 63/537,038, filed on Sep. 7, 2023.

(51) Int. Cl. H02H 9/04

(52) U.S. Cl. CPC H02H 9/04

(57) ABSTRACT

A wide input voltage range surge suppressor includes an inductor connected between an alternating current (“AC”) power input and a protected load, and a surge absorption circuit. The surge absorption circuit includes a capacitor, a resistor connected in parallel to the capacitor, and at least one crowbar device or clamping device connected in line with the capacitor.

### CROSS-REFERENCE TO RELATED APPLICATIONS

This application claims priority to U.S. Provisional Patent Application No. 63/537,038, filed on Sep. 7, 2023, titled “WIDE INPUT VOLTAGE RANGE SURGE SUPPRESSOR,” the entirety of which is incorporated by reference herein for all purposes.

### FIELD OF THE INVENTION

This disclosure relates generally to power line surge suppressors and, more specifically, to surge suppressors which are responsive to a wide input voltage range, e.g., in a range of less than 100 volts to higher than 2.5 kilovolts.

### BACKGROUND OF THE INVENTION

Electric and electronic loads receiving power from an external grid are sometimes subjected to high voltage surges. Such surges may arise from inductive loads, lightning strikes, or other phenomenon, and may cause damage to, or even destroy, electric and electronic equipment and devices. The highest potential transient spike voltages are short in duration, typically tens of microseconds. These high potential strikes may have voltages in the ranges of many thousands of volts (e.g., above 1.5 kV and up to 20 kV), at currents of many thousands of amperes. Such high voltages tend to overstress electronic equipment, components, motors, etc., creating unwanted and hazardous conditions. The high potentials and high current flow can cause such drastic stress that permanent damage or destruction can result.

In response to these problems, power main frequency isolation transformers in DC power supplies can be sometimes utilized to obtain energy from an alternating current (AC) power main to isolate power main voltage from the loads for surge protection. However, these devices are costly, large, and heavy. To reduce costs, weight and size, switched-mode voltage regulators can be utilized in certain circumstances, but these regulators are not completely reliable and may themselves be damaged by high-potential surges. Line surge suppressors can also be utilized sometimes, but they can be unreliable when subjected to lightning storm strikes.

Advancements in the area of surge protection systems are continually sought in the interests of performance, reliability, cost, and operability.

### SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention or to delineate the scope of the invention. The sole purpose of the summary is to present some concepts in a simplified form as a prelude to the more detailed description that is presented later.

According to an aspect of the invention, a wide input voltage range surge suppressor includes an inductor connected between an alternating current (“AC”) power input and a protected load, and a surge absorption circuit. The surge absorption circuit includes a capacitor, a resistor connected in parallel to the capacitor, and at least one “crowbar” device or clamping device connected in line with the capacitor.

In the wide input voltage range surge suppressor according to the foregoing aspect, the AC power input has line and neutral connections and the surge absorption circuit is connected between the line and the neutral connections or between the line connection and an earth ground.

In the wide input voltage range surge suppressor according to the foregoing aspect, the surge absorption circuit is connected is connected upstream of the inductor.

In the wide input voltage range surge suppressor according to the foregoing aspect, the inductor comprises a tap connected to the surge absorption circuit. The wide input voltage range surge protection system described herein relies on a line inductor, which is connected upstream to, and in-line with, the protected load, and a surge triggering and absorption circuit arranged upstream of the line inductor. The surge triggering and absorption circuit includes a capacitor, a resistor connected in parallel with the capacitor, and at least one crowbar device or clamping device connected in-line with the capacitor.

The surge protection system both diverts and blocks a significant portion of the surge current from reaching the protected load.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1A is an overall system block diagram of a wide input voltage range surge suppressor, according to an exemplary embodiment;

FIG. 1B is a circuit diagram of a wide input voltage range surge suppressor, according to an exemplary embodiment;

FIG. 2 is a circuit diagram of the surge protection circuit portion of the wide input voltage range surge suppressor of FIG. 1B, according to an exemplary embodiment;

FIG. 3 is a circuit diagram of the surge protection circuit portion of the wide input voltage range surge suppressor of FIG. 1B, according to another exemplary embodiment;

FIG. 4 is a circuit diagram of the wide input voltage range surge suppressor of FIG. 1B, according to another exemplary embodiment;

FIG. 5 is a circuit diagram of the wide input voltage range surge suppressor of FIG. 1B, according to an exemplary embodiment;

FIGS. 6A-6C illustrate plots of the output voltage deviation for a simulation circuit of the wide input voltage range surge suppressor of FIG. 5;

FIGS. 7A-7B illustrate plots of the surge current for a simulation circuit of the wide input voltage range surge suppressor of FIG. 5;

FIG. 8 illustrates experimental results based on a simulation circuit of the wide input voltage range surge suppressor of FIG. 1B;

FIG. 9 illustrates the shunt capacitor voltage based on a simulation circuit of the wide input voltage range surge suppressor of FIG. 1B; and

FIG. 10 is a circuit diagram of the surge protection circuit portion of the wide input voltage range surge suppressor of FIG. 3 including a monitoring circuit, according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE INVENTION

The invention will now be described by reference to exemplary embodiments and variations of those embodiments. Although the invention is illustrated and described herein with reference to specific embodiments, the illustrated examples are not intended to be limited to the details shown and described. Rather, various modifications may be made in the details within the scope and range of equivalents of the claims and without departing from the invention. For example, one or more aspects of the disclosed exemplary embodiments can be utilized in other embodiments and even other types of devices and/or input voltage ranges. Moreover, certain terminology is used herein for convenience only and is not to be taken as a limitation.

Power line surges within a building may be as large as 6,000 Volts, 3,000 Amperes, with a duration of 50 microseconds, according to the industry standard ANSI C62.41. In its Safety Standard for Surge Protective Devices, Underwriters Laboratories (“UL”) uses 6,000 Volts, 3,000 Amperes for its UL1449 safety duty factor (endurance) testing, and for establishing a Suppressed Voltage Rating (SVR). Power line surge suppressors should serve the purpose of reducing such electrical surges to benign levels of voltage, current and duration (energy). Most electronic equipment is powered from “switch mode” power supplies which generally take their power from the peak of the power wave, where they present a very low impedance to the power wave during the peak period of the wave, making them particularly susceptible to surges, which exceed the peak voltage of the power wave.

During a transient event, surge protection devices (“SPDs”) can provide a shunt path around the protected load, for example with Metal Oxide Varistors (“MOVs”), Gas Discharge Tubes (“GDTs”), transient-voltage-suppression (“TVS”) diodes, or a combination of these components. Some SPDs can further limit the surge current delivered to the load by providing a large in-line impedance at high frequencies by using a line inductor (aka. a choke). Regardless of the topology, any circuit that employs an MOV or TVS dissipates a substantial amount of power. In addition, MOVs tend to degrade over time and a TVS diodes can handle limited amounts of energy, both of which can lead to catastrophic failures of the protected equipment.

A need remains for an improved surge protection system that does not rely upon any active components (e.g., transistors, diodes), while achieving highly reliable surge protection without the use of “sacrificial components” (e.g., components that “wear out” with use), such as MOVs, TVS diodes, etc.

The waveform of a lightning strike type surge can be modeled as a 1.2×50 μs open circuit voltage with an 8×20 μs short circuit current, defined by IEEE 62.41.2 and IEC 61000-4-5.A similar surge waveform can be classified as a 100kHz “ring wave,” defined by IEC 61000-4-12.

The wide input voltage range surge suppressor described herein permits only an extremely small amount of surge energy to pass through it to the protected equipment, making it particularly effective for protecting such switch mode power supplies. Notably, the wide input voltage range surge suppressor described herein does not use “sacrificial” components which “wear out” with use, providing the benefit of long life in extreme electrical environments.

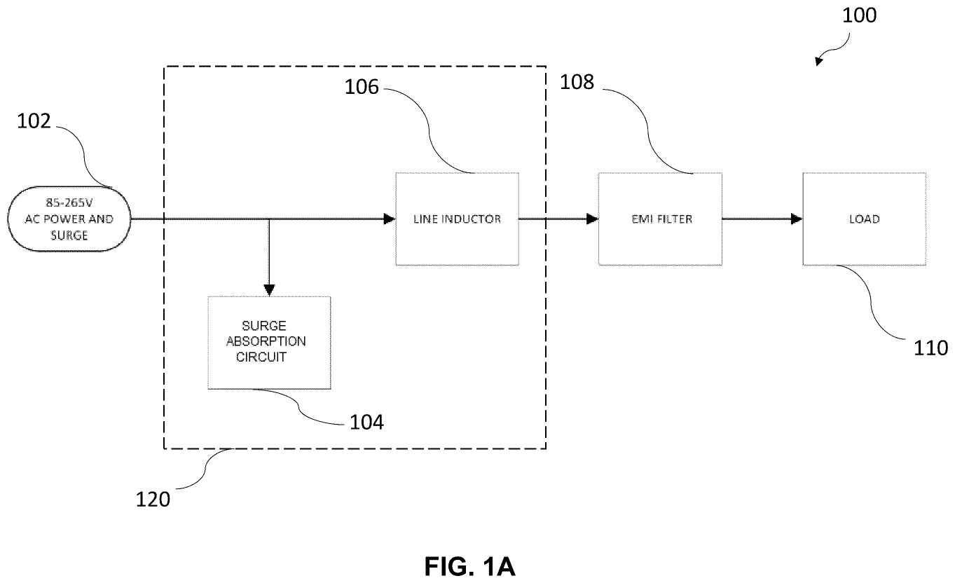

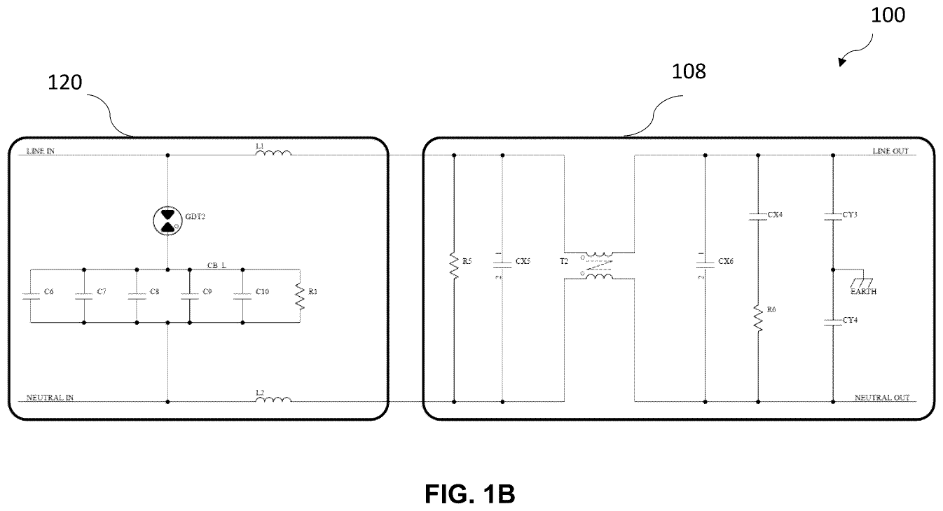

The block diagram of FIG. 1 shows the general components of an exemplary wide input voltage range surge suppressor 100, which has the unique capability of operating from 85 Volts RMS to 265 Volts RMS with effective dynamic surge energy suppression throughout the operating voltage range. The wide input voltage range surge suppressor 100 includes an AC power and surge source 102, a surge absorption circuit 104, a line inductor 106, an EMI filter 108, and a protected load 110. The AC power and surge source 102 includes a line connection and a neutral connection, via appropriate connectors or wires, for example. The EMI filter 108 is an industry standard low-impedance type design, and its details are not the subject of the present application.

The left portion of the wide input voltage range surge suppressor 100 that includes the surge absorption circuit 104 and the line inductor 106 will be referred to herein collectively as “surge protection circuit” 120.

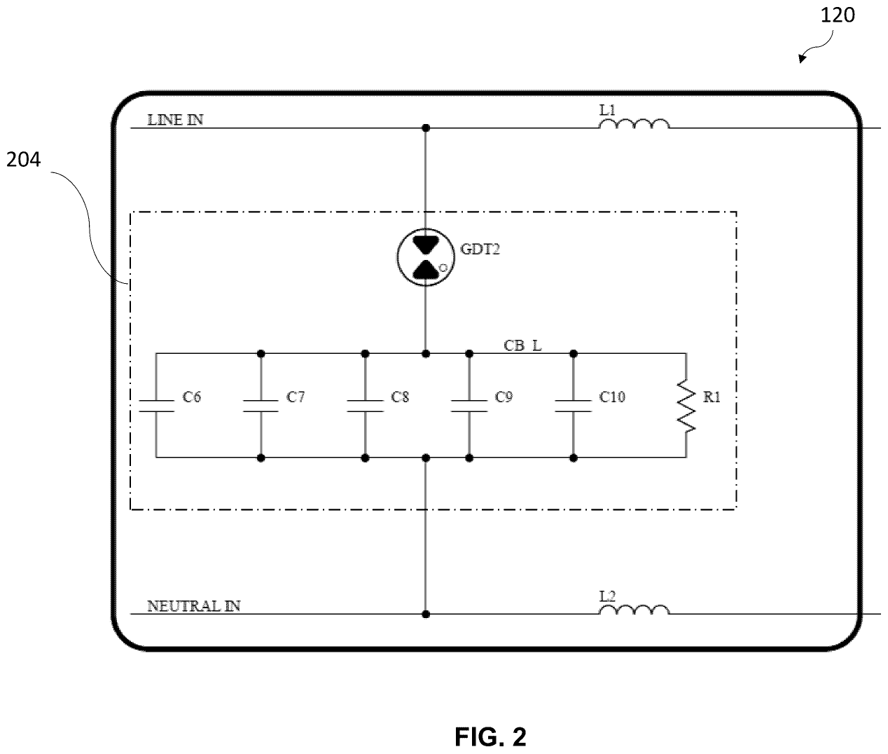

Referring now to FIG. 2, for example, an exemplary embodiment of the surge protection circuit 120 is disclosed. Specifically, the surge protection circuit 120 can include inductors L1 and L2, each of which is connected between the AC power input (e.g., AC power and surge source 102 in FIG. 1) and the protected load (e.g., protected load 110 in FIG. 1), and a surge absorption circuit 204. The inductors L1 and L2 are line inductors (e.g., chokes) placed in series (e.g., in line) with the conductors connecting the AC power and surge source 102 to the load 110. Due to the inductor's nature to resist a change in current, the line inductors L1 and L2 can act as a near open-circuit to an incoming surge. In other words, the inductors L1 and L2 block or impede changes in current and function as a low pass filter.

The surge absorption circuit 204 is connected upstream of the inductors L1 and L2, and in line with, the protected load 110. The surge absorption circuit 204 is connected between the line connection and the neutral connection of the AC power and surge source 102 (FIG. 1). Alternatively, the surge absorption circuit 204 can be connected between the line connection of the AC power and surge source 102 (FIG. 1) and earth ground.

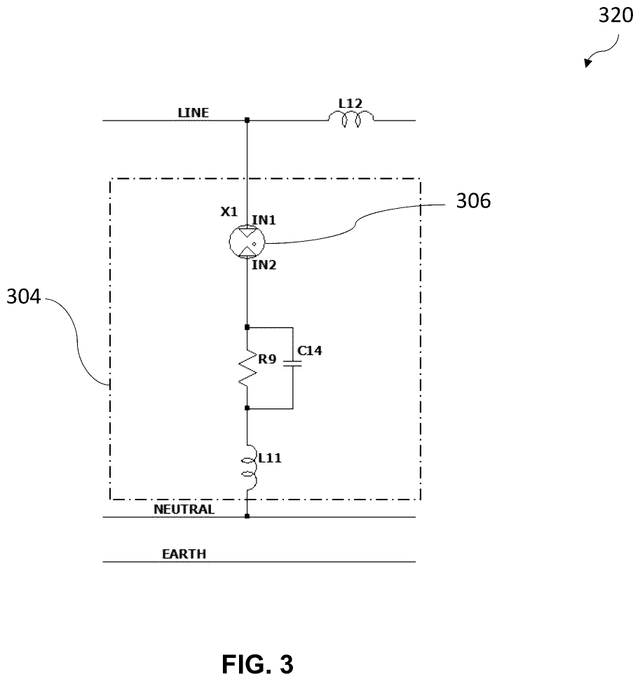

Although FIG. 2 illustrates two line inductors L1 and L2, embodiments are not limited thereto and other configurations may be utilized. For example, in certain exemplary embodiments, such as FIG. 3, for example, a surge protection circuit 320 can include only one line inductor L12 and a surge absorption circuit 304. The surge absorption circuit 304 in the exemplary embodiment of FIG. 3 is connected upstream of the inductor L12, and in line with, the protected load 110.

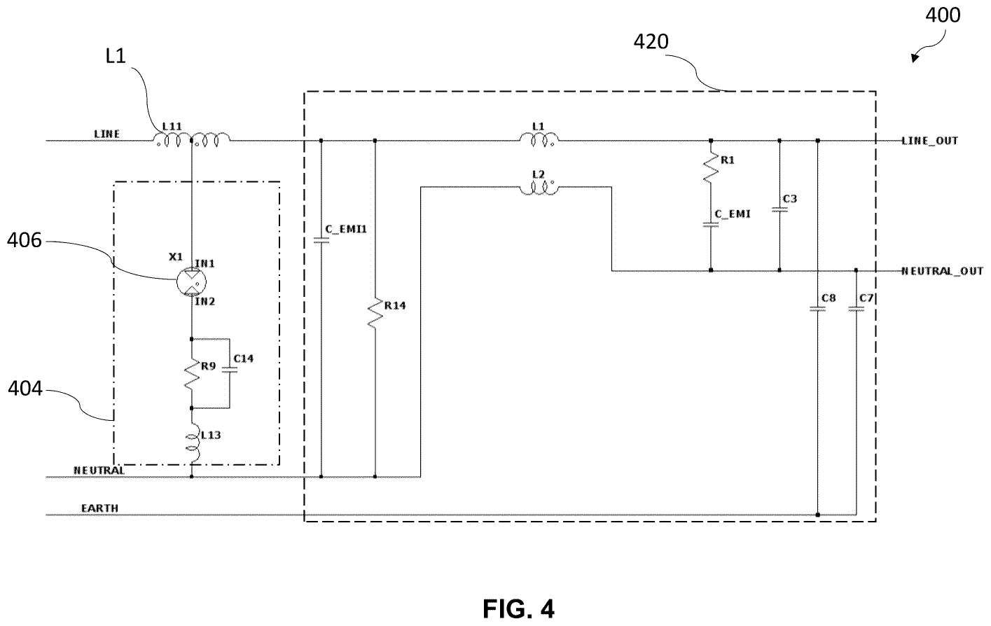

The line inductor L1 can be tapped. For example, in certain exemplary embodiments, such as FIG. 4, for example, a surge protection circuit 420 can include only one line inductor L1 (including sub-inductors L11, L12) and a surge absorption circuit 404. A tap from the inductor L1 (e.g., a point between sub-inductors L11, L12) can be connected to the surge absorption circuit 404.

Alternatively, if no tap in inductor L1 is available, the surge absorption circuit 420 can be connected upstream of the line-inductor L1, similar to FIG. 3, for example.

Turning now to FIG. 3, the surge absorption circuit 304 includes a capacitor C14. The capacitor C14 is a shunt capacitor connected in parallel with the power supply 102 and the protected load 110. The capacitor C14 can be, for example, a large capacitor bank having a total capacitance value between 150 μF and 200 μF. For example, as illustrated in FIG. 2, the surge absorption circuit 204 can include a capacitor bank including capacitors C6, C7, C8, C9, C10, each having a capacitance value of 40 μF. The capacitor bank including capacitors C6, C7, C8, C9, C10 can have a total capacitance value of 200 μF, in this particular exemplary embodiment.

Alternatively, the surge absorption circuit 204 can include a single capacitor C14 (FIG. 3) instead of a capacitor bank. The capacitor C14 can be, for example, a large capacitor having a total capacitance value between 150 μF and 200 μF. However, embodiments are not limited thereto and other configurations may be utilized. For example, in certain exemplary embodiments, the surge absorption circuit 204 (304, 404) can include a full-bridge rectifier to allow the use of a physically smaller, polarized, electrolytic capacitor.

Due to capacitor's nature to resist a change in voltage and the inductor's nature to resist a change in current, the shunt capacitor C14 can act as a near short-circuit and the series inductor L1 can act as a near open-circuit to the incoming surge. The energy that is absorbed in the capacitor C14 (or in the capacitor bank including capacitors C6, C7, C8, C9, C10) during the surge event can be slowly discharged via a parallel resistor R1 (FIG. 2) or R9 (FIGS. 3 and 4), e.g., connected in parallel to the capacitor bank including capacitors C6, C7, C8, C9, C10 or in parallel to the capacitor C14, respectively.

At line frequencies (e.g., 50/60 Hz), a shunt capacitor bank, such as capacitor C14 or the capacitor bank including capacitors C6, C7, C8, C9, C10, for example, can generate a large, unwanted, current draw. This issue can be resolved by connecting at least one crowbar device or clamping device, such as a Gas Discharge Tube (“GDT”) or a MOV, for example, in line (e.g., in series) with the capacitor C14 or the capacitor bank including capacitors C6, C7, C8, C9, C10. Crowbar devices can also include (in addition to a GDT) Thyristor Integrated Surge Protectors (“TISP”), plasma surge arrestors, spark gap devices, and silicon controlled rectifiers (“SCRs”). Crowbar devices can limit the current flow into the protected circuit by abruptly switching from a high impedance state, e.g., an open circuit, to a low impedance state, e.g., a short circuit, responsive to the circuit voltage exceeding a set impedance switching threshold level. During a high impedance state, no current flows through the crowbar device and no power is consumed. Once switched into the low impedance state, the voltage across the crowbar device is at a relatively low level and the device does not dissipate a significant portion of the power delivered during the overvoltage event but rather passes the power from line to ground. For example, once the voltage across a GDT exceeds a characteristic gas breakdown voltage (e.g., the GDT threshold voltage), the GDT switches to a low impedance state where the voltage across the GDT is less than 15 volts. Because of these properties, crowbar devices are suited for operating in high current conduction modes for relatively long periods of time, allowing for the protection of circuits during relatively long surges. Clamping devices can include MOVs, TVS diodes, and Zener (e.g., avalanche) diodes, for example. In contrast to crowbar devices, clamping devices can limit the voltage transient to a specified voltage level by varying the clamping device's internal resistance responsive to the applied voltage. With a MOV device, the clamping device's internal resistance changes with the applied voltage so that the MOV acts as a voltage sensitive, nonlinear resistive element in parallel with the protected circuit. As a clamping device must absorb the surge energy at the clamped voltage, clamping devices cannot withstand the same high level of surge current as a gas discharge tube. MOVs also suffer from high current surges causing cumulative degradation and performance changes. Due to the above-described disadvantages of using MOVs (e.g., dissipation of power, degradation over time, etc.), a GDT can be a better solution than a MOV in blocking the unwanted current draw generated from the shunt capacitor C14 (or the capacitor bank including capacitors C6, C7, C8, C9, C10). In addition, MOVs can also introduce a large (e.g., higher than 200V) clamping voltage, while GDTs can introduce a smaller (e.g., lower than 50V) voltage, which can be another advantage of using a GDT.

Turning back to FIG. 2, a GDT2 (e.g., a crowbar device) can be connected in line with the capacitor bank including capacitors C6, C7, C8, C9, C10. The GDT2 only conducts current during a surge event, and during normal operating conditions blocks the unwanted current draw generated from the capacitor bank including capacitors C6, C7, C8, C9, C10. Because the capacitor bank including capacitors C6, C7, C8, C9, C10 is connected via the GDT2, under normal operation (e.g., no significant surge or “brownout” events, during utility companies lower their power line voltage to conserve available electrical power), nearly 0 volts are present across the capacitor bank including capacitors C6, C7, C8, C9, C10. In the event of a surge, the GDT2 can “break over” and begin conducting. Only then will the capacitor bank including capacitors C6, C7, C8, C9, C10 begin to charge. Initially, the capacitor voltage will be near 0 volts, but due to the largely uni-polar nature of the surge current, the capacitor bank including capacitors C6, C7, C8, C9, C10 will begin to charge. Similarly, after a surge event, the GDT2 continues to conduct current with “follow-through current” since the arc persists inside the device. After a surge event, the line frequency becomes dominant, and the capacitor bank including capacitors C6, C7, C8, C9, C10 can provide a sufficient impedance to limit the follow-through current to a level at which the arc can self-extinguish.

Similarly, in the exemplary embodiments illustrated in FIGS. 3 and 4, a GDT 306 (or 406) can be connected in line with the capacitor bank C14. The GDT 306 (or 406) only conducts current during a surge event, and during normal operating conditions blocks the unwanted current draw generated from the shunt capacitor C14. Similarly, after a surge event, the GDT 306 (or 406) continues to conduct with “follow-through current” since the arc persists inside the device. After a surge event, the line frequency becomes dominant, and the capacitor C14 can provide a sufficient impedance to limit the follow-through current to a level at which the arc can self-extinguish.

Another downside of using a large capacitor bank, such as the capacitor C14 of the capacitor bank including capacitors C6, C7, C8, C9, C10, for example, can be the large current spike generated as the GDT 2 (306, 406) begins to conduct current. This issue can be diminished or resolved by using a small, series inductor that can act to limit the rate of change of the current through the capacitor C14 or the capacitor bank including capacitors C6, C7, C8, C9, C10, for example. For example, turning back to FIGS. 3 and 4, a second inductor L13 can be connected in series with the capacitor C14 or the capacitor bank including capacitors C6, C7, C8, C9, C10. The second inductor L13 can have a relatively small inductance value (e.g., 10 nH), and can act to limit the rate of change of the current through the capacitor C14 or the capacitor bank including capacitors C6, C7, C8, C9, C10.

However, the use of the second inductor L13 is optional, and certain embodiments, such as the surge absorption circuit 204 illustrated in FIG. 2, for example, do not include a second inductor L13 that is connected in series with the capacitor bank including capacitors C6, C7, C8, C9, C10.

Optionally, certain exemplary embodiments of the surge protection circuit can use MOVs, TVS diodes, etc. (e.g., a clamping device), instead of a GDT. Yet other exemplary embodiments can use parallel crowbar devices or clamp-type devices, such as MOVs, GDTs, thyristors, or TVS diodes, instead of a GDT.

Other exemplary embodiments can use both a crowbar device and a clamping device, such as a GDT and an MOV, for example, connected in series to each other and in line (e.g., in series) with the capacitor C14 or the capacitor bank including capacitors C6, C7, C8, C9, C10.

Certain exemplary embodiments of the surge protection circuit can include at least two surge absorption circuits, such as a first surge absorption circuit connected upstream of the inductor L1 (e.g., between the AC power and surge source 102 and a first end of the inductor L1 that is closer to the AC power and surge source 102 than to the protected load 110) and a second surge absorption circuit connected downstream of the inductor L1 (e.g., between the protected load 110 and a second end of the inductor L1 that is closer to the protected load 110 than to the AC power and surge source 102), for example.

Other exemplary embodiments of the surge protection circuit can include more than two surge absorption circuits, such as a first and a second surge absorption circuits connected upstream of the inductor L1 in a common mode arrangement between line and earth or line and neutral, respectively, and a third surge absorption circuit connected downstream of the inductor L1 (e.g., between the protected load 110 and a second end of the inductor L1 that is closer to the protected load 110 than to the AC power and surge source 102), for example.

Other exemplary embodiments of the surge protection circuit can include shunt capacitor(s) and GDT branch(es) connected downstream of the line-inductor(s) L1, L2.

Yet other exemplary embodiments of the surge protection circuit can include other parallel, shunt branches including crowbar and/or clamp-type devices upstream or downstream of the line inductor L1.

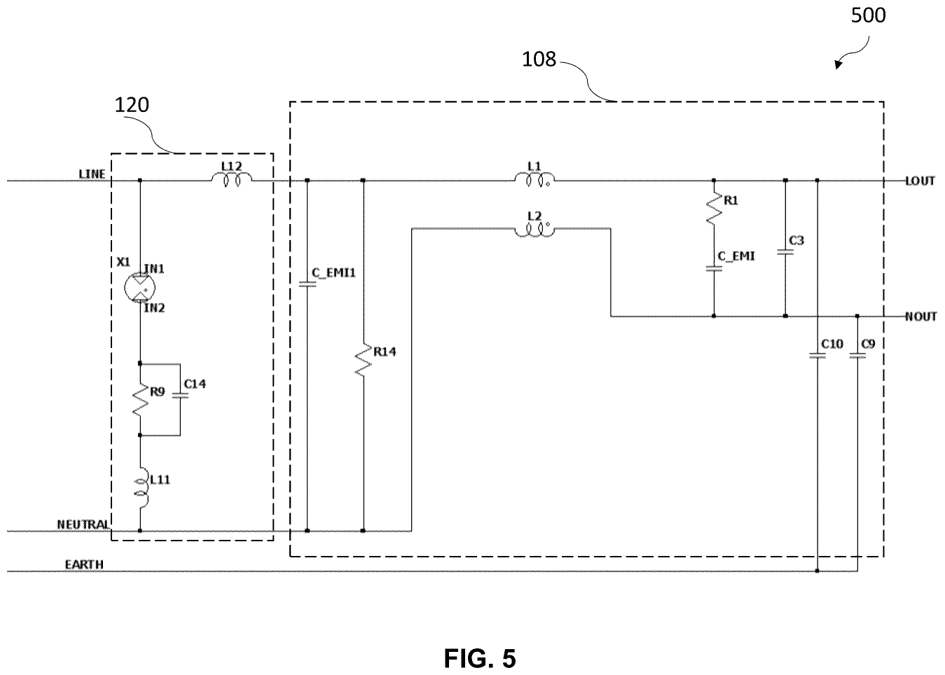

FIG. 5 is a circuit diagram of a simulation circuit 500 of an exemplary wide input voltage range surge suppressor. A typical EMI filter 108, placed between the surge protection circuit 120 and the load 110, can further divert much of the remaining surge current away from the load 110.

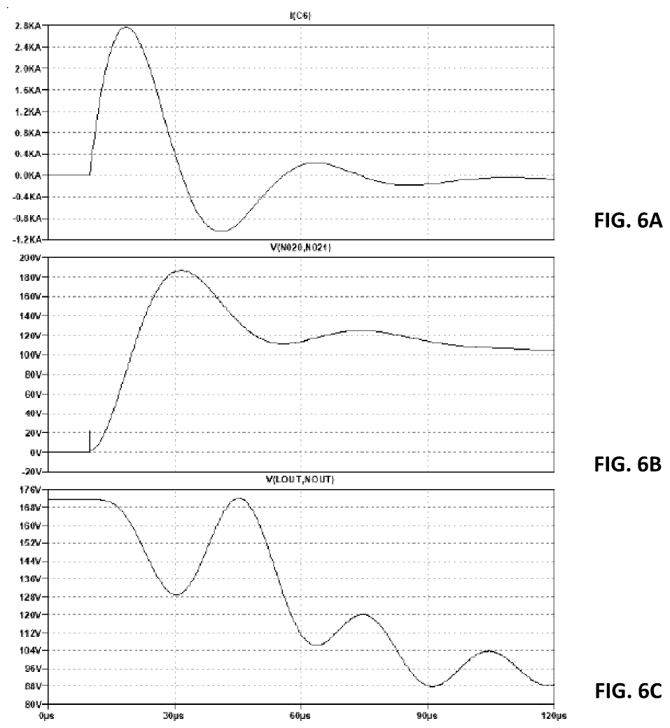

Utilizing the wide input voltage range surge suppressor illustrated in FIG. 5 above, simulations and experimental tests were conducted over a range of voltages with a 2.8 kA surge to demonstrate the efficacy of the wide input voltage range surge suppressor for varied voltages. A prototype was created, based on a simulated circuit, and prototype values for various components were obtained using data sheets and running a model of the wide input voltage range surge suppressor through an LTspice software module. The experimental results closely match those of the simulation. Any discrepancies can be explained by the simplified GDT model, as well as the exclusion of parasitic resistances and inductances in the modeled components (e.g., ground resistance, lead inductance, etc.). Because the GDT model is an approximation, experimental results may vary. Actual results are disclosed below. FIGS. 6A-6C through 9 illustrate the results. In each of these figures, the applied surge voltage and the let-through voltage are plotted against time.

The simulation implements a discrete model of a 1.2×50 μs/8×20 μs combination wave generator, per IEC 61000-4-5. This generator uses a storage capacitor, which was given an initial condition of 6615V to achieve the necessary 6 kV open-circuit (OC) voltage. The generator is capacitively coupled across line and neutral, and the surge was applied at 90° on the 120V AC waveform. Simulation data shows a suppression of the surge within the first 100 μs, with the use of a typical downstream EMI filter.

FIGS. 6A-6C illustrate the output voltage deviation, with FIG. 6A illustrating the surge current, FIG. 6B illustrating the capacitor voltage, and FIG. 6C illustrating the output voltage.

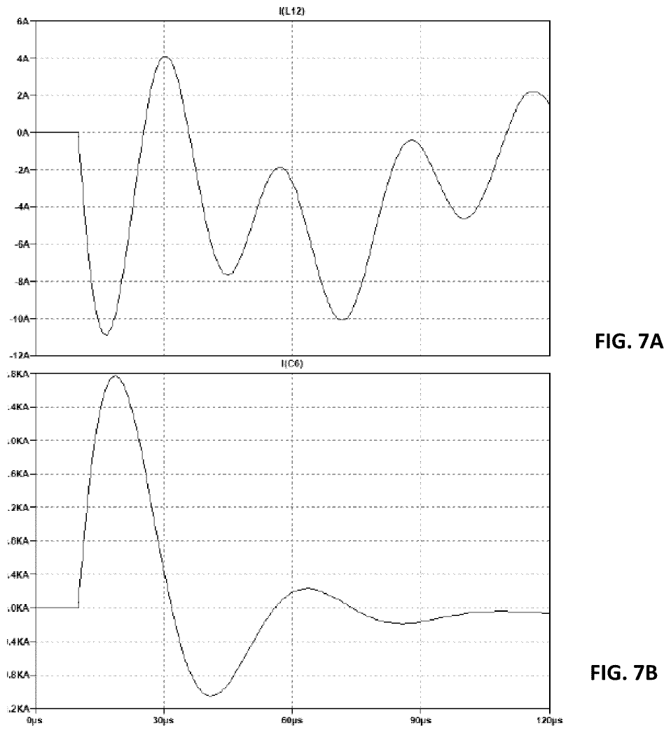

FIGS. 7A and 7B illustrate that nearly all the surge current is absorbed by the capacitor C14. FIGS. 7A and 7B illustrate the surge currents, with FIG. 7A illustrating the unabsorbed surge current and FIG. 7B illustrating the surge and capacitor currents.

The simulation results described above, and illustrated in FIGS. 2 and 3, assumed the absence of dissipative components. The optimum values of the resistance, capacitance, and inductance can be determined by testing and experimentation.

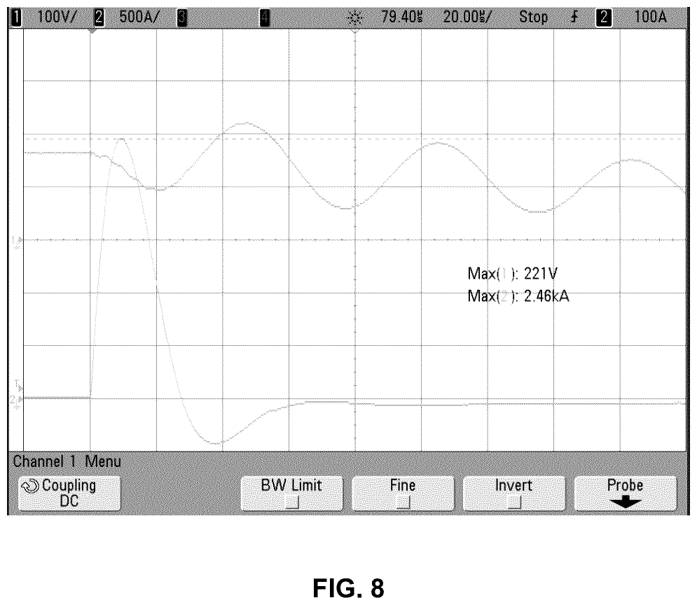

FIG. 8 illustrates experimental results based on the simulation circuit illustrated in FIG. 1B. The EMI filter 108 was integrated into a PCB to only have a single board. The let-through voltage was measured via a differential probe across the line and neutral of the power outlet, without any load (per UL1449). The surge generator was a Keytech 587 and was configured as follows:

. 1.2×50 μs/8×20 μs combination wave (“Bi-wave”), charged to 6 kV,
Normal mode (line to neutral),
Applied at 90° of the AC waveform,
Positive polarity.

The simulation surge protection circuit 120 illustrated in FIG. 1B (best shown as surge absorption circuit 204 in FIG. 2) includes five capacitors C6, C7, C8, C9, C10, each having a capacitance value of 40 μF, for a total capacitance value of 200 μF, connected in parallel to each other, two line inductors L1 and L2, each having an inductance value of 40 μH, a GDT 2 with a value of AC120L (e.g., 285 V 5000 A (5 kA), 10GΩ) and a resistor R1 with a resistance value of 10kΩ, 3W.

Turning back to FIG. 8, the surge was applied at 90°, and the output voltage closely matches the results generated by the simulation. Discrepancies in the results can be explained by the GDT model used in the simulation, as well as the lack of parasitic elements (e.g., resistance, inductance, etc.) included in the simulation.

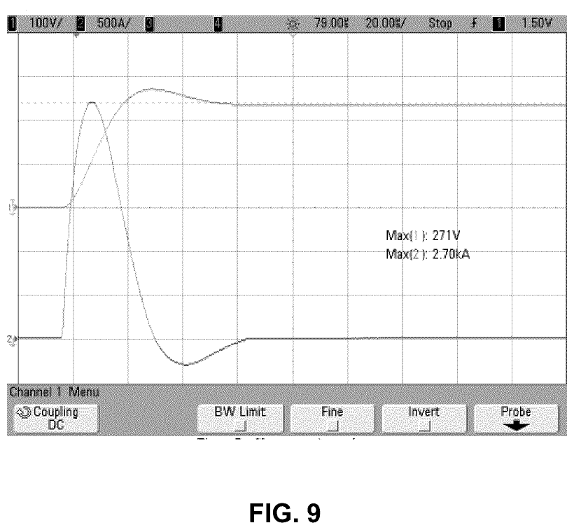

FIG. 9 illustrates the shunt capacitor voltage. FIG. 9 shows that nearly all the surge current is absorbed by the capacitor C14.

Surge protection devices, such as GDTs, for example, break down discharge with surge overvoltage during long-term use due to cumulative discharge. See, e.g., Lingyun Cheng et al. “Experimental Study on the Short-Circuit Failure Mechanism of Cumulative Discharge in Gas Discharge Tube,” published in IEEE Transactions on Plasma Science (Volume: 49, Issue: 9, September 2021). Although cumulative discharge in GDT is unlikely in most cases, there is a risk of short-circuit failure due to the drop in insulation resistance after a certain number of discharges, which can be caused by cumulative discharge. Id. Notably, the insulation resistance of the GDT decreases significantly during the last 10% of the GDT life cycle, which can cause the GDT to fail and can lead to a short circuit through the GDT, in response to a large, unwanted, current draw that can be generated by a shunt capacitor bank, such as capacitor C14 (FIG. 3) or the capacitor bank including capacitors C6, C7, C8, C9, C10 (FIG. 2), for example, at line frequencies (e.g., 50/60 Hz). In the present surge suppressor circuit, the GDT is connected with a series inductance to increase the rise time and with a series capacitor or capacitor bank to store most of the surge energy. With this configuration, there would be minimal effect on the GDT, making it a robust design.

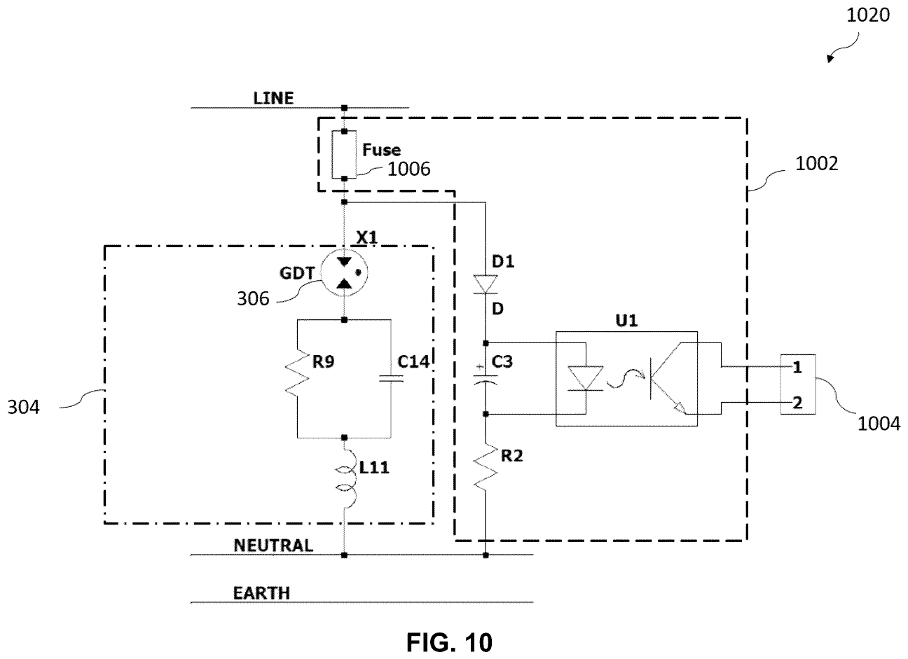

FIG. 10 is a circuit diagram of an exemplary surge protection circuit 320 portion of the wide input voltage range surge suppressor of FIG. 3, including a monitoring circuit 1002. The monitoring circuit 1002 is connected in parallel to the surge absorption circuit 304 between the line connection side of the surge absorption circuit (and the GDT 306) and the neutral connection of the AC power and surge source 102 (FIG. 1). The monitoring circuit 1002 can be used to monitor the voltage across the surge absorption circuit 304, which correlates to the status of the GDT 306, and to transmit the detected voltage values to a controller, a processor, or a control circuit 1004. The monitoring circuit 1002 can include, for example, a fuse 1006, a diode D1, a filter capacitor C3 connected in series with a current limiting resistor R2, and an optocoupler U1. If the fuse 1006 is blown, e.g., due to long-term use and cumulative discharge in the GDT, no current will flow through the monitoring circuit 1002, past the fuse 1006, in order to drive the optocoupler U1, which can lead to an open signal (e.g., to a connector) that can be sensed by the controller, processor, or control circuit 1004. However, embodiments are not limited to the circuit configuration of the monitoring circuit 1002 shown in FIG. 10, and other circuit configurations of the monitoring circuit 1002 may be utilized.

The circuit design of the wide input voltage range surge suppressor illustrated in the figures, and described above, functions optimally and essentially independently of the supply voltage, giving it superior performance independent of transient events and enabling optimum protection for wide input voltage range equipment using switch-mode power supplies. For example, the wide input voltage range surge suppressor described herein is suitable for circuits operating in both the 110V-120V voltage range and the 220V-240V voltage range.

The surge protection system both diverts and blocks a significant portion of the surge current from reaching the protected load. The surge protection system described herein provides highly reliable surge protection without the use of “sacrificial components” (e.g., components that “wear out” with use), such as MOVs, TVS diodes, etc.

Although the invention is illustrated and described herein with reference to specific exemplary embodiments, the invention is not intended to be limited to the details shown. Rather, various modifications may be made in the details within the scope and range of equivalents of the claims and without departing from the invention.

What is claimed is:

1. A wide input voltage range surge suppressor, comprising:
an inductor connected between an alternating current (“AC”) power input and a protected load; and
a surge absorption circuit, comprising:
a capacitor;
a resistor connected in parallel to the capacitor; and
at least one crowbar device or clamping device connected in line with the capacitor.

2. The wide input voltage range surge suppressor of claim 1, wherein the AC power input has line and neutral connections and the surge absorption circuit is connected between the line and the neutral connections or between the line connection and an earth ground.

3. The wide input voltage range surge suppressor of claim 1, wherein the inductor is a line inductor.

4. The wide input voltage range surge suppressor of claim 1, wherein the inductor comprises a tap connected to the surge absorption circuit.

5. The wide input voltage range surge suppressor of claim 1, wherein the capacitor is a shunt capacitor.

6. The wide input voltage range surge suppressor of claim 1, wherein the capacitor is connected upstream of the inductor and in line with the protected load.

7. The wide input voltage range surge suppressor of claim 1, wherein the capacitor is a capacitor bank having a capacitance between 150 μF and 200 μF.

8. The wide input voltage range surge suppressor of claim 1, wherein the at least one crowbar device or clamping device is a Gas Discharge Tube (“GDT”).

9. The wide input voltage range surge suppressor of claim 8, wherein the GDT is connected between the AC power input and the inductor.

10. The wide input voltage range surge suppressor of claim 1, wherein the at least one crowbar device or clamping device is at least one of a Metal Oxide Varistor (“MOV”) or a Transient Voltage Suppression (“TVS”) diode.

11. The wide input voltage range surge suppressor of claim 1, wherein the at least one crowbar device or clamping device is at least one of a Metal Oxide Varistor (“MOV”) or a Transient Voltage Suppression (“TVS”) diode connected in parallel between the AC power input and the protected load.

12. The wide input voltage range surge suppressor of claim 1, further comprising two inductors connected between the AC power input and the protected load.

13. The wide input voltage range surge suppressor of claim 12, wherein the surge absorption circuit is connected to first ends of the two inductors, said first ends being closer to the AC power input than to the protected load.

14. The wide input voltage range surge suppressor of claim 1, wherein the surge absorption circuit is connected upstream of the inductor.

15. The wide input voltage range surge suppressor of claim 1, further comprising a second surge absorption circuit connected downstream of the inductor.

16. The wide input voltage range surge suppressor of claim 1, further comprising a second inductor connected in series with the capacitor.

17. The wide input voltage range surge suppressor of claim 16, wherein the second inductor has an inductance value of 10 nH.

18. The wide input voltage range surge suppressor of claim 1, wherein the capacitor is an electrolytic capacitor.

19. The wide input voltage range surge suppressor of claim 18, further comprising a full-bridge rectifier.

20. The wide input voltage range surge suppressor of claim 1, further comprising a monitoring circuit connected in parallel to the surge absorption circuit between a line connection of the AC power input and a neutral connection of the AC power input.
